(19) United States
(12) Patent Application Publication
(10) Pub. No.: US 2023/0384135 A1
(43) Pub. Date: Nov. 30, 2023

(54) CORIOLIS MEASURING TRANSDUCER, AND CORIOLIS MEASURING DEVICE

(71) Applicant: Endress+Hauser Flowtec AG, Reinach (CH)

(72) Inventors: Hao Zhu, Freising (DE); Ennio Bitto, Aesch (DE); Gerhard Eckert, Grenzach-Wyhlen (DE)

(21) Appl. No.: 18/250,118

(22) PCT Filed: Sep. 23, 2021
(86) PCT No.: PCT/EP2021/076257

§ 371 Date: Apr. 21, 2023

(30) Foreign Application Priority Data
Oct. 26, 2020 (DE) 10 2020 128 094.7

(51) Int. Cl. G01F 1/84

(52) U.S. Cl. CPC G01F 1/8413; G01F 1/8477

(57) ABSTRACT

A Coriolis measuring transducer comprises a pair of measuring tubes; an exciter; at least two sensors; and two manifolds. Each measuring tube has a first outer measuring tube bend and a second outer measuring tube bend. Each measuring tube pair has a first group of at least two fixing elements and a second group of at least two fixing elements. The fixing elements have, along the measuring tube centerline, a first separation from outer ends of the measuring tube bends of at most 0.7 bend length. The outer measuring tube bends have, in each case, at least one stiffening element, wherein the stiffening elements are arranged between the groups of fixing elements, wherein the stiffening elements have, in each case, a second separation from an inner end of their measuring tube bend of at least 0.2 bend length.

The invention relates to a Coriolis measuring transducer as well as to a Coriolis measuring device having a Coriolis measuring transducer for registering a property of a medium located in measuring tubes of the measuring transducer. Media properties of interest are, in such case, usually density or mass flow of the medium.

Coriolis measuring devices utilize the feature that measuring tube oscillations produced by an exciter are influenced by media properties. Measurement signals of the oscillations produced by sensors can be evaluated, in order to win desired information concerning the media properties. In order to define the measuring tube oscillations, in such case, usually fixing elements are provided, which define oscillation nodes. In the case of Coriolis measuring transducers having a measuring tube pair, this is accomplished usually with at least two fixing elements per oscillation node; see, for example, DE102005046319A1.

These fixing elements, however, limit an oscillation range of a measuring tube and, thus, a measuring power of the Coriolis measuring device.

An object of the invention is, consequently, to expand the oscillation range of a measuring tube.

The object is achieved by a Coriolis measuring transducer as defined in independent claim 1 as well as by a Coriolis measuring device as defined in independent claim 6.

A Coriolis measuring transducer of the invention for a Coriolis measuring device for measuring a property of a medium flowing through a pipeline comprises:
at least one pair of measuring tubes for conveying the medium and having, in each case, an inlet, an outlet, a measuring tube wall enclosing a measuring tube lumen, as well as, in each case, a measuring tube centerline;
at least one exciter for producing measuring tube oscillations as well as an inlet end, first sensor and an outlet side, second sensor for registering measuring tube oscillations;
two manifolds, which are adapted to receive the medium from the pipeline and to distribute such into the measuring tubes or to receive the medium and return such into the pipeline,
wherein the measuring tubes have, in each case, a first outer measuring tube bend and a second outer measuring tube bend, each of which has a bend length;
per measuring tube pair, in each case, a first group of fixing elements having at least two fixing elements and a second group of fixing elements having at least two fixing elements, wherein the first group is arranged in the region of the first measurement tube bend and the second group is arranged in the region of the second measuring tube bend, wherein the groups of fixing elements are adapted, in each case, to define a measuring tube oscillation node, wherein the fixing elements, in each case, fix the measuring tubes of the measuring tube pair relative to one another,
wherein the fixing elements have, in each case, along the measuring tube centerline a first separation from outer ends of the measuring tube bends, which separation is at most 0.7 bend length and, especially, at most 0.5 bend length,
wherein the outer measuring tube bends have, in each case, at least one stiffening element, wherein the stiffening elements are arranged between the groups of fixing elements,
wherein the stiffening elements have, in each case, a second separation from an inner end of their measuring tube bend, wherein the second separation is at least 0.1 bend length, wherein the stiffening elements are arranged, in each case, on one measuring tube.

Limiting the first separation enlarges the oscillation range. The stiffening elements limit in the region of the outer measuring tube bends a dependence of the measuring tube diameter on a media pressure.

Such a dependence has significant effects on a stiffness of the measuring tubes and, thus, on their oscillation characteristics.

The combination of the limiting of the first separation and the provision of stiffening elements in the region of the measuring tube bends between the measuring tube groups thus improves the measuring power by increasing the oscillation range.

The measuring tube centerline is a line through centers of measuring tube cross-sections.

In an embodiment, the measuring transducer has at least 2 stiffening elements per measuring tube bend.

In this way, the dependence of the measuring tube diameter on the media pressure can be further decreased.

In an embodiment, the stiffening element is ring shaped or follows a ring form.

The stiffening element thus at least partially surrounds the measuring tube, and secures a periphery of the measuring tube.

In an embodiment, the stiffening element has, as the measuring tube, a first material or is produced from this material.

The first material is, in such case, a metal, especially a stainless steel, or a ceramic or a plastic

In an embodiment, the measuring tube has a measuring tube wall thickness,
wherein the stiffening element has an outer radius, which is at least a measuring tube wall thickness greater than a measuring tube radius
and/or
wherein the stiffening element has along the measuring tube centerline a breadth of at least 1 millimeter and at most 15 millimeter.

In this way, the stiffening element can act against a measuring tube internal pressure and compel in very good approximation a measuring tube diameter that remains constant.

In an embodiment, the outer measuring tube bends have relative to the measuring tube centerline, in each case, a bend radius of less than 5 measuring tube diameters and/or at least 2 measuring tube diameters. In the case of a given measuring tube length, for example, established by external specifications, a fraction of the outer measuring tube bends to a measuring tube length can be limited by limiting the bend radii. A minimum size assures that the measuring tubes have a sufficiently high quality in the region of the measuring tube bends and are not damaged by the process for producing the bends.

In an embodiment, the media property to be determined is mass flow or density.

A Coriolis measuring device of the invention comprises a Coriolis measuring transducer of the invention and an electronic measuring/operating circuit for operating the exciter, for registering measurement signals of the sensors and for providing measured values of the media property.

The invention will now be described based on examples of embodiments presented in the appended drawing, the figures of which show as follows:

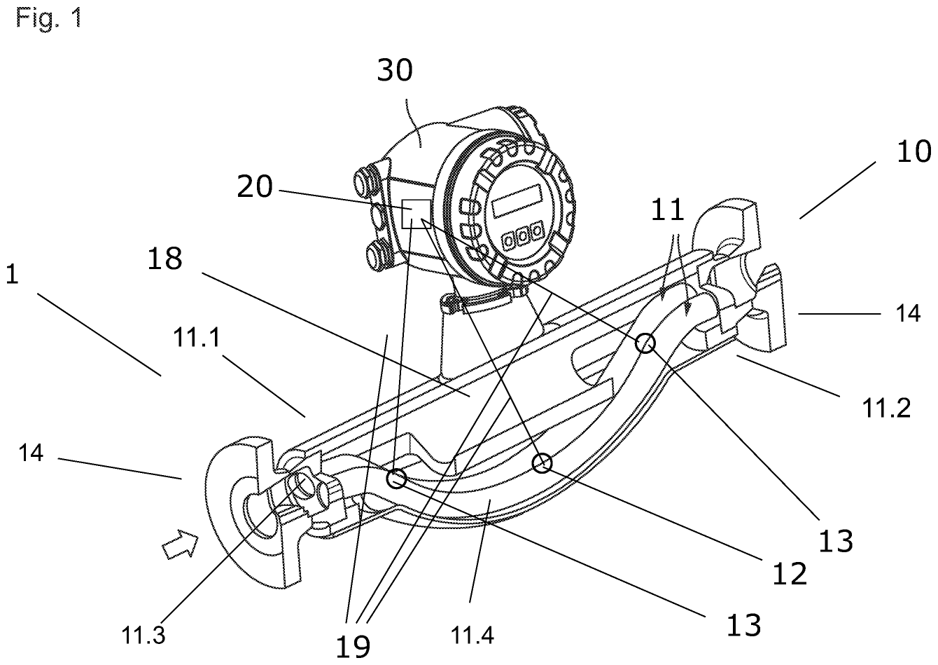

FIG. 1 by way of example, a Coriolis measuring device; and

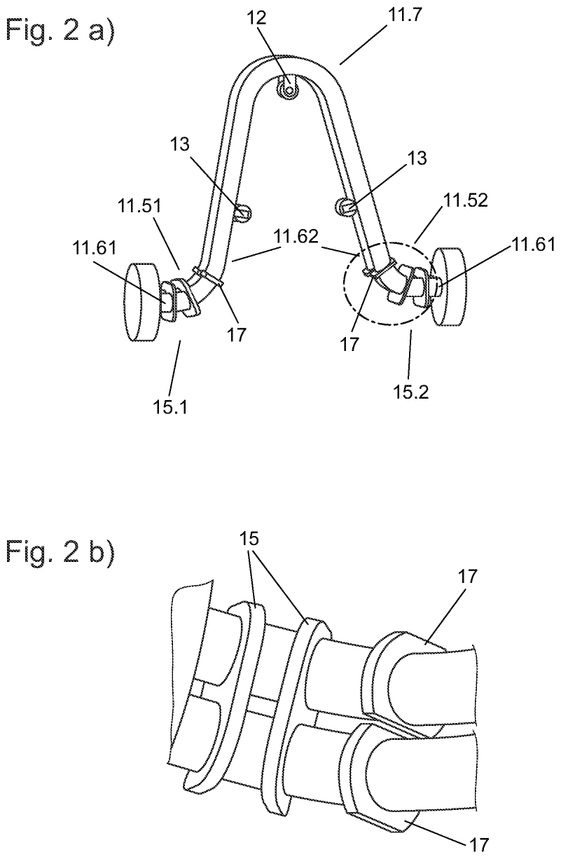

FIGS. 2 a) and 2 b) a Coriolis measuring transducer of the invention.

FIG. 1 shows, by way of example, a Coriolis measuring device 1 having a Coriolis measuring transducer 10, an electronic measuring/operating circuit 20 and a housing 30 for housing the electronic measuring/operating circuit. The Coriolis measuring transducer includes a pair of measuring tubes 11, each having an inlet 11.1 and an outlet 11.2. Arranged on both ends of the measuring tubes are manifolds 14, which are adapted to distribute the medium from a pipeline into the measuring tubes and to return the medium from the measuring tubes into the pipeline. An exciter 12 is adapted to produce measuring tube oscillations, and sensors 13 are adapted to register measuring tube oscillations. The electronic measuring/operating circuit serves for operating the exciter, for registering measurement signals of the sensors and for providing measured values of the media property of a medium flowing through a measuring tube lumen 11.3 formed by a measuring tube wall 11.4. The Coriolis measuring transducer includes a support body 18 for supporting the measuring tubes.

FIG. 2 a) shows an embodiment of the invention for a pair of measuring tubes of a Coriolis measuring transducer of the invention and FIG. 2 b) shows a detailed enlargement of the region of FIG. 2 a) marked with a circle. The measuring tubes have, in each case, a first outer measuring tube bend 11.51 and a second outer measuring tube bend 11.52, wherein the outer measuring tube bends have, in each case, an outer end 11.61 and an inner end 11.62.

The Coriolis measuring transducer includes a first group of fixing elements 15.1 having two fixing elements 15 as well as a second group of fixing elements 15.2 having two fixing elements 15. The groups of fixing elements are adapted to define an oscillatory node point at each of the outer measuring tube bends.

The outer measuring tube bends have, in each case, a bend length, wherein according to the invention the fixing elements have, in each case, a first separation of at most 0.7 bend length, and, especially, at most 0.5 bend length, from their outer ends. In this way, an oscillation swing of the measuring tube is increased. The Coriolis measuring transducer can, in such case, also have more than two fixing elements 15 per group 15.1, 15.2.

According to the invention, furthermore, each outer measuring tube bend has a stiffening element 17, which supports and reinforces the measuring tube against media pressure. In this way, dependence of the measuring tube diameters on media pressure in the region of the outer measuring tube bends is reduced and, thus, a stiffness of the measuring tubes is stabilized. It is possible, however, also to provide more than only one stiffening element 17 per outer measuring tube bend 11.51, 11.52. The stiffening elements have, in each case, a second separation from the inner ends 11.62 of their measuring tube bends, wherein the second separation is at least 0.1 bend length, wherein the stiffening elements are arranged, in each case, on one measuring tube.

In an embodiment, the outer measuring tube bends have, measured to the measuring tube centerline, in each case, a bend radius of less than 5 measuring tube diameters and/or at least 2 measuring tube diameters. In the case of a given measuring tube length, for example, as established by external specifications, a limiting of the bend radii can limit a fraction of the outer measuring tube bends to a measuring tube length. A minimum size assures that sufficient space for the fixing elements and the stiffening elements is present.

The measuring tubes can, such as shown here, have between the outer measuring tube bends a central measuring tube bend 11.7, which is connected with the outer measuring tube bends by means of two straight sections.

In case the measuring transducer has more than one measuring tube pair, then fixing elements can, in each case, fix a pair of measuring tubes or more than one pair of measuring tubes.

In an embodiment, the stiffening element is ring shaped or follows a ring form.

A stiffening element thus surrounds any given measuring tube at least partially and reinforces a periphery of the measuring tube. In an embodiment, the stiffening element comprises, as the measuring tube, a first material or is produced from such material. The first material is, in such case, a metal, especially a stainless steel, or a ceramic or a plastic.

In an embodiment, the measuring tube has a measuring tube wall thickness, wherein the stiffening element has an outer radius, which is at least one measuring tube wall thickness more than a measuring tube radius and/or
wherein the stiffening element has along the measuring tube centerline a breadth of at least 1 millimeter and at most 15 millimeter.

In this way, the stiffening element can act against a measuring tube internal pressure and restrain in very good approximation a measuring tube diameter to remains constant.

Between the manifolds and the outer ends of the outer measuring tube bends, a straight measuring tube section can be arranged. In this way, it is assured that the manifold is connected with a measuring tube section of circularly shaped cross section. The process of bending the measuring tube bends causes locally small deviations from a circularly round shape of measuring tube cross-sections. Such can be disadvantageous for welding of manifold and measuring tube.

### LIST OF REFERENCE CHARACTERS

1 Coriolis measuring device
10 Coriolis measuring transducer
11 measuring tube
11.1 inlet
11.2 outlet
11.3 measuring tube lumen
11.4 measuring tube wall
11.51 first outer measuring tube bend
11.52 second outer measuring tube bend
11.53 bend length
11.61 outer end
11.62 inner end
11.7 central measuring tube bend
12 exciter
13 sensor
14 manifold
15 fixing element
15.1 first group
15.2 second group
17 stiffening element
18 support body
19 electrical connection lines
20 electronic measuring/operating circuit
30 housing

1-8. (canceled)

9. A Coriolis measuring transducer for a Coriolis measuring device for measuring a property of a medium flowing through a pipeline, comprises:
a pair of measuring tubes for conveying the medium, each measuring tube having an inlet, an outlet, a measuring tube wall enclosing a measuring tube lumen, and a measuring tube centerline, wherein each measuring tube has a first outer measuring tube bend and a second outer measuring tube bend, each of which has a bend length;
at least one exciter for producing measuring tube oscillations;
at least two sensors for registering measuring tube oscillations;
two manifolds adapted to receive the medium from the pipeline and to distribute the medium into the measuring tubes and to receive the medium from the measuring tubes and to return the medium into the pipeline;
a first group of at least two fixing elements and a second group of at least two fixing elements, wherein the first group of at least two fixing elements is arranged in a region of the first outer measuring tube bend and the second group of at least two fixing elements is arranged in a region of the second outer measuring tube bend, wherein the groups of fixing elements are adapted to define a measuring tube oscillation node, wherein the fixing elements secure the measuring tubes of the measuring tube pair relative to one another,
wherein the fixing elements have, in each case, along the measuring tube centerline, a first separation from outer ends of the measuring tube bends of at most 0.7 bend length,
wherein the outer measuring tube bends have, in each case, at least one stiffening element, wherein the stiffening elements are arranged between the groups of fixing elements, wherein the stiffening elements have, in each case, a second separation from an inner end of their measuring tube bend of at least 0.1 bend length, wherein the stiffening elements are arranged, in each case, on one measuring tube.

10. The Coriolis measuring transducer as claimed in claim 9, further comprising:
at least 2 stiffening elements per measuring tube bend.

11. The Coriolis measuring transducer as claimed in claim 10,
wherein the stiffening elements are ring-shaped or follow a ring form.

12. The Coriolis measuring transducer as claimed in claim 11,
wherein the stiffening element has, as the measuring tube, a first material or is produced from this material.

13. The Coriolis measuring transducer as claimed in claim 12,
wherein each measuring tube has a measuring tube wall thickness,
wherein each stiffening element has an outer radius that is at least a measuring tube wall thickness greater than a measuring tube radius, and/or
wherein each stiffening element has along the measuring tube centerline a breadth of at least 1 millimeter and at most 15 millimeters.

14. The Coriolis measuring transducer as claimed in claim 9,
wherein the outer measuring tube bends have, relative to the measuring tube centerline, in each case, a bend radius of less than 5 measuring tube diameters and/or at least 2 measuring tube diameters.

15. The Coriolis measuring transducer as claimed in claim 9,
wherein the media property is mass flow or density.

16. A Coriolis measuring device, comprising:
a Coriolis measuring transducer, including:
a pair of measuring tubes for conveying the medium, each measuring tube having an inlet, an outlet, a measuring tube wall enclosing a measuring tube lumen, and a measuring tube centerline, wherein each measuring tube has a first outer measuring tube bend and a second outer measuring tube bend, each of which has a bend length;
at least one exciter for producing measuring tube oscillations;
at least two sensors for registering measuring tube oscillations;
two manifolds adapted to receive the medium from the pipeline and to distribute the medium into the measuring tubes and to receive the medium from the measuring tubes and to return the medium into the pipeline;
a first group of at least two fixing elements and a second group of at least two fixing elements, wherein the first group of at least two fixing elements is arranged in a region of the first outer measuring tube bend and the second group of at least two fixing elements is arranged in a region of the second outer measuring tube bend, wherein the groups of fixing elements are adapted to define a measuring tube oscillation node, wherein the fixing elements secure the measuring tubes of the measuring tube pair relative to one another,
wherein the fixing elements have, in each case, along the measuring tube centerline, a first separation from outer ends of the measuring tube bends of at most 0.7 bend length,
wherein the outer measuring tube bends have, in each case, at least one stiffening element, wherein the stiffening elements are arranged between the groups of fixing elements, wherein the stiffening elements have, in each case, a second separation from an inner end of their measuring tube bend of at least 0.1 bend length, wherein the stiffening elements are arranged, in each case, on one measuring tube;
an electronic measuring/operating circuit for operating the at least one exciter, for registering measurement signals of the at least two sensors, and for providing measured values of the media property; and
a housing for housing the electronic measuring/operating circuit.
